(19) United States
(12) Patent Application Publication
(10) Pub. No.: US 2026/0256656 A1
(43) Pub. Date: Sep. 3, 2026

(54) CONTAINMENT DEVICE FOR STOMA TREATMENTS

(71) Applicants: Martin Claus von Dyck, Concord, NC (US); Jasmine Sturr, Whittier, CA (US)

(72) Inventors: Martin Claus von Dyck, Concord, NC (US); Jasmine Sturr, Whittier, CA (US)

(21) Appl. No.: 19/232,276

(22) Filed: Jun. 9, 2025

Related U.S. Application Data
(60) Provisional application No. 63/765,112, filed on Feb. 28, 2025.

(51) Int. Cl. A61J 15/00

(52) U.S. Cl. CPC A61J 15/0061; A61J 15/0015; A61J 15/0096

(57) ABSTRACT

A flexible containment device for containing stoma treatment substances such as powders, gels, lotions and gauze pads at the stomatic site is disclosed. The stomatic site containment device contains the stomatic exudate and stoma treatment substances via one or more ridge ring barriers. The stomatic site containment device prevents stoma fluid leakage onto clothing and bed linens. The stomatic site containment device is adapted for use with a gastrostomy device, a jejunostomy device, or other medical devices having catheters or conduits fitted in a stoma. Further, the stomatic site containment device has a low profile so as to be placed underneath the catheter’s external retention mechanism and over the patient’s stoma.

### CROSS REFERENCE TO RELATED APPLICATION

This application claims the benefit of priority of U.S. provisional application number 63/765,112, filed Feb. 28, 2025, the contents of which are herein incorporated by reference.

### BACKGROUND OF THE SUBJECT DISCLOSURE

The subject disclosure relates to medical devices for use with catheters or enteral feeding systems, and more particularly to a stoma exudate treatment and containment device dimensioned and adapted to operatively associate with the catheter of a patient, wherein the removable containment device is adapted to accommodate and contain various stomatic leakage treatment options for absorbing stomatic exudate and keeping stomas dry and less irritated. It is to be understood that that term ‘stomatic’ used herein is to describe something related to a stoma, wherein a stoma is an artificial, surgically created opening in the body of a patient.

Stoma exudate refers to the discharge, often a liquid or mucus-like substance, coming from a stoma (a surgically created opening between an organ and the external environment). This exudate can be a normal part of stomatic function, but changes in its appearance, amount, or color could indicate a problem, such as infection or irritation. As a result, patients that have, say, enteral catheters that rely on stomas often have exudate leakage which results in odor, skin irritation, and fluid leaking onto clothing and bed linens. A common practice is to use gauze pads and fabric pads around stomatic sites to collect this exudate leakage; however, these pads act as absorptive wicks that allow fluid transfer of the exudate to clothing and bed linens. Other attempts to control exudate leakage include using stoma treatment powders, gels, and lotions. These treatment substances, unfortunately, also tend to escape the confines of the stomatic site and thus allow the exudate to do the same.

As can be seen, there is a need for a removable and re-attachable containment device adapted to accommodate and circumscribe various stomatic leakage treatment options for containing and absorbing stomatic exudate at or immediately around the stoma site, keeping the stoma dry and less irritated.

### SUMMARY OF THE SUBJECT DISCLOSURE

The subject disclosure prevents stoma fluid leakage contacting the patient’s clothing and bed linens by containing the stoma exudate and related treatment powders, ointments, pads or the like via a ridge ring or barrier. The ridge ring is the barrier that defines a compartment or cavity for containing exudate fluid and stoma treatment substances, preventing their leakage, thereby enabling the orderly and efficient containment of stoma exudate treatments such as fluid absorbing powders, fluid absorbing gels, lotions and fabric type absorptive dressings.

The subject disclosure is adapted for efficient placement underneath the catheter’s external retention device irrespective the catheter type or if the catheter is adjustable or fixed.

In one aspect of the subject disclosure, a stomatic site containment device provides the following: a planar base having a conduit receiving hole dimensioned and shaped to receive a medical conduit associated with the stomatic site; the planar base being elastic so as to biased to move from a plurality of deformed conditions to a biased condition; an installation channel cleaving the planar base from the conduit receiving hole to a perimeter of the planar base; a raised ridge projecting from a bottom side of the planar base along said perimeter thereof so that opposing ends of the raised ridge contact in the biased condition and are uncontacted in the plurality of deformed conditions; and the raised ridge terminating at an engagement surface configured to engage a patient and thereby defining a containment cavity around the stomatic site.

In another aspect of the subject disclosure, the stomatic site containment device further provides the following: a plurality of ventilation holes along the bottom surface, between the conduit receiving hole and the raised ridge, wherein the planar base is translucent to allow visualization of the containment cavity, or wherein the planar base is opaque to prevent visualization of the containment cavity; a handle extending from the perimeter of the planar base from a point diametrically opposed to the installation cavity, wherein the installation channel is closed along a substantial length thereof in the biased condition and spread in each of the plurality of deformed conditions, wherein the conduit receiving hole is centrally disposed in the planar base, and wherein the conduit receiving hole and ventilation holes extend through the planar base from the bottom side to a top side thereof; and further providing an inner barrier having a substantially same depth as the raised ridge, wherein the inner barrier is disposed between the conduit receiving hole and the ventilation holes.

In yet another aspect of the subject disclosure, a method of containing a plurality of elements of a stoma treatment adjacent to a stomatic site includes engaging an aforementioned stomatic site containment device to a skin of a patient so that the raised ridge of said stomatic site containment device circumscribes both the stomatic site and the plurality of elements of the stoma treatment.

These and other features, aspects and advantages of the present subject disclosure will become better understood with reference to the following drawings, description and claims.

### BRIEF DESCRIPTION OF THE DRAWINGS

FIG. 1 is a perspective view of an exemplary embodiment of the subject disclosure, shown in use.

FIG. 2 is a top perspective view of an exemplary embodiment of the subject disclosure.

FIG. 3 is a bottom perspective view of an exemplary embodiment of the subject disclosure.

FIG. 4 is a bottom plan view of an exemplary embodiment of the subject disclosure.

FIG. 5 is a section view taken along line 5-5 in FIG. 4.

FIG. 6 is an exploded perspective view of an exemplary embodiment of the subject disclosure, illustrating a stomatic site containment device 10 operative association with a conduit 40 of a catheter 38.

FIG. 7 is a perspective view of an exemplary embodiment of the subject disclosure, shown operatively associated with the conduit 40 of the catheter 38.

FIG. 8 is a flow chart of an exemplary embodiment of the subject disclosure.

FIG. 9A is a bottom plan view of an exemplary embodiment 42 of the subject disclosure.

FIG. 9B is a bottom plan view of an exemplary embodiment 44 of the subject disclosure.

FIG. 9C is a bottom plan view of an exemplary embodiment 46 of the subject disclosure.

FIG. 9D is a bottom plan view of an exemplary embodiment 48 of the subject disclosure.

FIG. 9E is a bottom plan view of an exemplary embodiment 50 of the subject disclosure.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims. Broadly, an embodiment of the subject disclosure provides a stomatic site containment device.

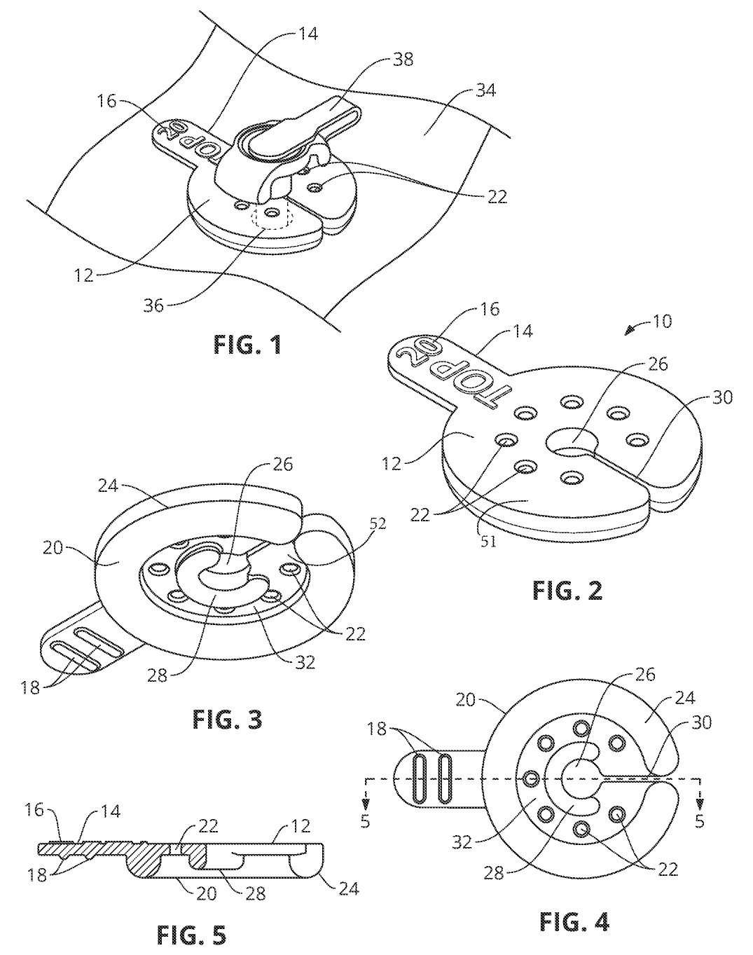

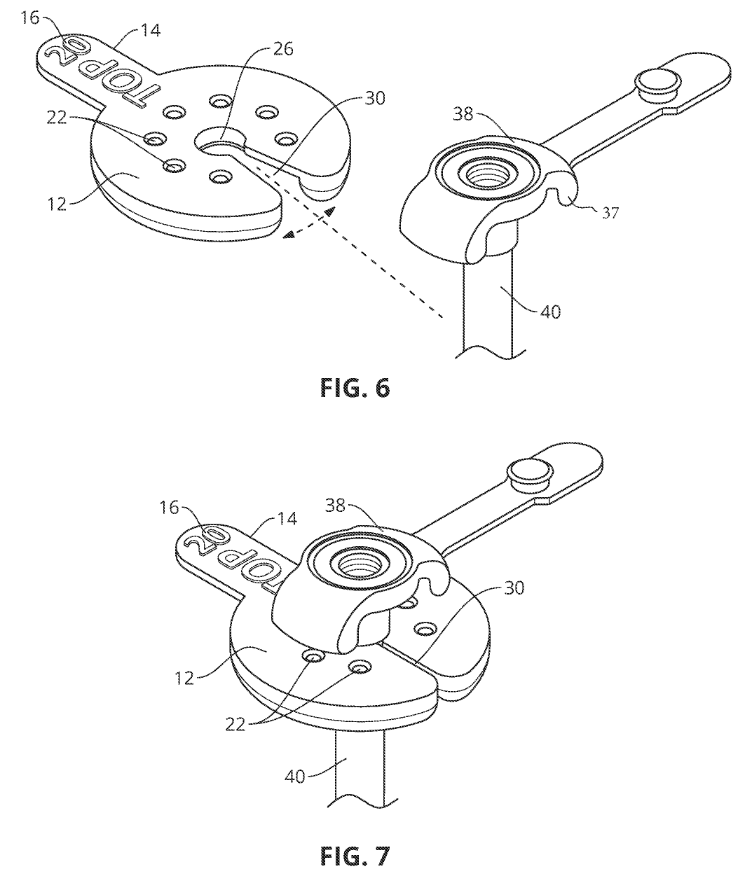

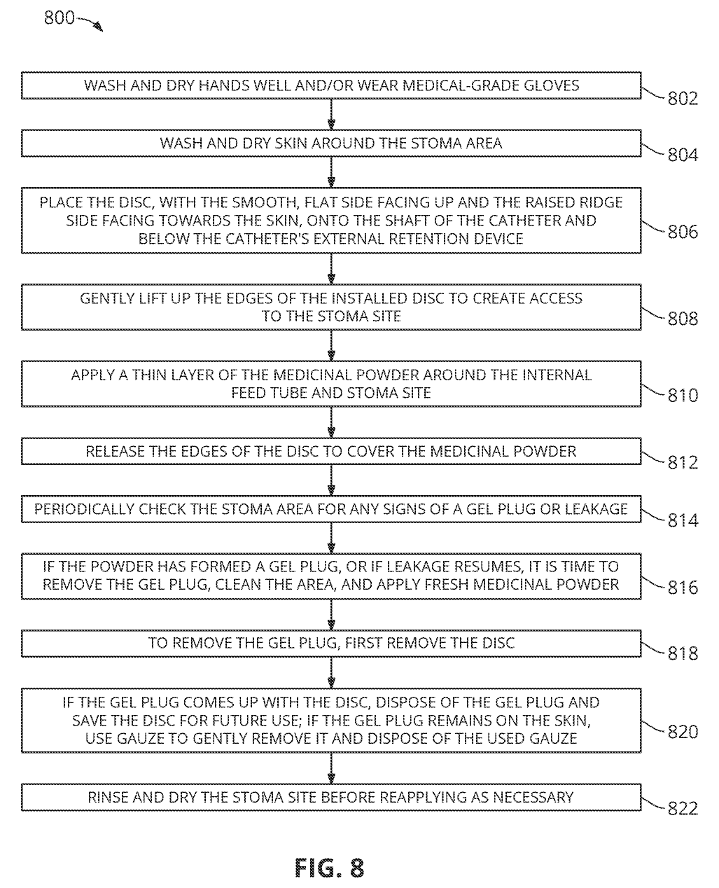

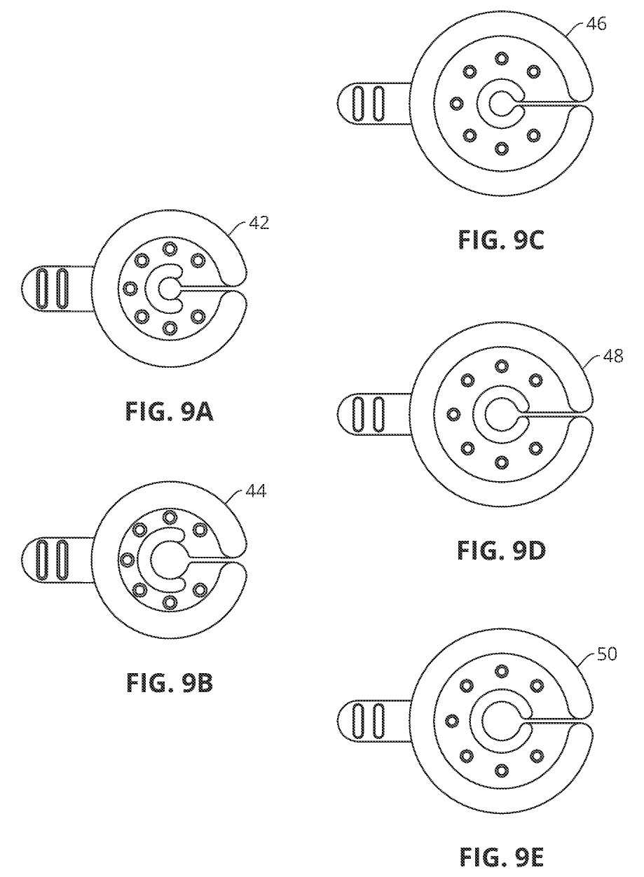

Referring to FIGS. 1 through 9E, the subject disclosure may include a stomatic site containment device 10. The stomatic site containment device 10 provides a base 12 that is generally planar and is, in certain embodiments, generally circular, but need not be. Base 12 defines a conduit receiving hole 26 that is typically not required to be, centrally located along the base 12. An installation channel 30 interconnects or communicates the conduit receiving hole 26 with an external periphery of the base 10 so that a conduit 40 may be slid through the installation channel 30 and into the conduit receiving hole 26. In a biased condition the width of the installation channel 30 may be one-tenth or less than that of a diameter of the conduit receiving hole 26. The stomatic site containment device 10 is elastic and thereby allows a user to pinch, twist, stretch, and bend the base 12, which includes being able to spread portions the base 12 to increase the width of the installation channel 30, as illustrated in FIG. 6. Importantly, because of the elastic nature of the base, the installation channel 30 may in effect be closed in said biased condition, whereby the opposing sides of the installation channel 30 touch.

Spaced apart (in some embodiments, radially spaced apart) ventilation holes 22 surround the conduit receiving hole 26, wherein the ventilation holes extend through the base 12 from a first side 51 thereof to a second side 52 thereof.

A handle tab 14 typically extends from a periphery of base 12. A first side of the handle tab 14 is generally flush with the first side 51 of base 12. Along the first side of the handle tab 14 an indicator indicium 16 may be provided. The indicator indicium 16 may include raised symbols that indicate a practitioner size associated with the stomatic site containment device 10. Along the second side, opposite the first side of the handle tab 14, a gripping texture 18 may be provided to facilitate the practitioner getting a grip on the handle tab 14. The raised symbols of the indicator indicium 16 may also provide a gripping element.

Along the second surface 52 of base 12 just outward of the conduit receiving hole 26 may be an inner barrier 28 for reinforcing the conduit receiving holes as well as assisting in containment of the stoma treatment elements. The inner barrier 28 may be arcuate is form, thereby taking on a horseshoe shape. The inner barrier 28 has a depth (in a direction protruding from said second surface 52) and a thickness (orthogonal relative to the depth direction) such that the entirety of the inner barrier 28 is disposed between but spaced apart from the ventilation holes 22 and the conduit receiving hole 26. Also projecting from the second surface 52 of base 12, outward of the ventilation holes 22, is an outer barrier 24 that generally extends along an entirety of a periphery of the base 12, thereby ending at opposing sides of the installation channel 30. Because of the elastic nature of the containment device 10, the opposing ends of the outer barrier 24 may touch in the biased condition.

The depth of the outer barrier 24 is approximately the same as the depth of the inner barrier 28 so that they can both simultaneously engage a generally planar surface, such as the skin of a patient. Thus, an engagement surface 20 of the outer barrier is approximately at the same elevation, relative to said second surface 52, as compared to the inner barrier 28. The thickness of the outer barrier 24, and thus the engagement surface 20, is typically greater than that of the inner barrier 28. The outer barrier 24 and the inner barrier 28 may be ridges.

The area under the second surface 52 of base 12 that is circumscribed by the outer barrier 24 defines a containment cavity 32 for the extent of the depth of the outer barrier 24.

The stomatic site containment device 10 may be used with a gastrostomy and/or jejunostomy catheter 38 inserted inside a patient 34, wherein the containment cavity 32 defined by the base 12 and outer barrier 24 contains stoma exudate and related treatment substances of the patient’s stomatic site 36 within the containment cavity 32.

The stomatic site containment device 10 is removable and able to be reattached, thereby facilitating the treatment and monitoring of the stomatic site 36 of the patient 34, including the various treatment options for absorbing stomal exudate and for various treatment options to keep stomas dry and less irritated. This stomatic site containment device 10 allows for the orderly and efficient containment of stoma exudate treatments such as fluid absorbing powders, fluid absorbing gels, lotions and fabric type absorptive dressings.

The low profile of the stomatic site containment device 10 allows for efficient placement underneath an external retention device 37 of a catheter 38 irrespective if they are adjustable or fixed. The low profile may be defined by a total depth, from the first surface 51 to the engagement surface 20, that is less than two centimeters.

Examples of catheter types compatible with the stomatic site containment device 10 include, but are not limited to, percutaneous gastrostomy catheters (PEG), percutaneous jejunostomy catheters, low-profile and standard replacement gastrostomy catheters, low-profile and standard jejunostomy catheters and other catheter types or conduits 40 operatively associated with a stoma site 36. Other types of non-catheter conduits 40 used to pass through a stoma may also be engaged by the stomatic site containment device 10.

The construction of the stomatic site containment device 10 may utilize injection and cast molds, 3D printing, or the like to allow for low-cost manufacturing of the stomatic site containment device 10 so that it is flexible, elastic, and/or articulatable in-order to be placed around the catheter shaft.

A method of using the subject disclosure by a practitioner may include the following steps: step 802 - wash and dry hands well and/or wear medical grade gloves; step 804 - wash and dry skin around the stoma area; and step 806 - urging the engagement surface 20 against the skin of the patient before or after sliding the conduit 40 of the catheter 38 within the conduit receiving hole 26, through the installation channel 30 so as to form the containment cavity 32 around the stomatic site 36 so that treatment fluid, stomatic treatment powder, and/or other stomatic treatment elements are contained within the containment cavity. In step 808 – the practitioner may gain access to the stomatic site 36 by gently urging the outer barrier 24 engagement surface 20 away from the skin of the patient 34, it being understood that due to the flexibility and elasticity of the stomatic site containment device 10 the base 12 may be pinched, folded, twisted and otherwise manipulated to facilitate such access. At step 810, the practitioner may apply a thin layer of stomatic treatment substance around the stoma site 36, which in some instance may be for an enteral feed tube. The practitioner may then release the edges of the stomatic site containment device 10 to cover the stomatic treatment substance and enclosing the containment cavity 32 there around. At step 814, the practitioner may periodically check the stoma area for any signs of a gel plug or leakage; for instance, at step 816, if the practitioner has noticed the stomatic treatment substance has formed a gel plug or if leakage resumes, it is time to remove the gel plug, clean the area, and apply fresh stomatic treatment substance. In step 818, the practitioner may remove the gel plug through removal of the stomatic site containment device 10, and if the gel plug comes up with the disc, dispose of the gel plug, and possibly clean and save the stomatic site containment device 10 for future use (wash with soap and water before reusing) at step 820. If the gel plug remains on the skin, use gauze to gently remove it and dispose of the used gauze. Rinse and dry the stoma site before reapplying as necessary at step 822.

The practitioner should be mindful to keep the cap tightly closed to prevent moisture from entering the bottle, and if they are using gauze or fabric pads, be aware that these materials may allow fluid to wick into the fabric and potentially transfer stomal fluid to clothing and bed linens. Also, the practitioner may apply a thin layer of stomatic treatment substant around the medical conduit 40, such as but not limited to an enteral feed tube, and stoma site 36. Daily checks of the stomatic site 36 are prudent. To remove a gel plug, the practitioner may want to first remove the gauze or fabric pad. If the gel plug comes up with the gauze or fabric pad, dispose of the gel plug. If the gel plug remains on the skin, use gauze to carefully remove it and dispose of it. Wash and dry the stoma site before reapplying as needed, and keep the cap tightly closed to prevent moisture from entering the bottle.

As used in this application, the term "about" or "approximately" refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A stomatic site containment device comprising:
a planar base having a conduit receiving hole dimensioned and shaped to receive a medical conduit associated with the stomatic site;
the planar base being, by way of effective elasticity, biased to move from a plurality of deformed conditions to a biased condition;
an installation channel cleaving the planar base from the conduit receiving hole to a perimeter of the planar base;
a raised ridge projecting from a bottom side of the planar base along said perimeter thereof so that opposing ends of the raised ridge contact in the biased condition and are uncontacted in the plurality of deformed conditions; and
the raised ridge terminating at an engagement surface configured to engage a patient and thereby defining a containment cavity around the stomatic site.

2. The stomatic site containment device of claim 1, further comprising a plurality of ventilation holes along the bottom surface, between the conduit receiving hole and the raised ridge.

3. The stomatic site containment device of claim 1, wherein the planar base is translucent to allow visualization of the containment cavity.

4. The stomatic site containment device of claim 1, wherein the planar base is opaque to prevent visualization of the containment cavity.

5. The stomatic site containment device of claim 1, further comprising a handle extending from the perimeter of the planar base from a point diametrically opposed to the installation cavity.

6. The stomatic site containment device of claim 1, wherein the installation channel is closed along a substantial length thereof in the biased condition and spread in each of the plurality of deformed conditions.

7. The stomatic site containment device of claim 1, wherein the conduit receiving hole is centrally disposed in the planar base.

8. The stomatic site containment device of claim 2, wherein the conduit receiving hole and ventilation holes extend through the planar base from the bottom side to a top side thereof.

9. The stomatic site containment device of claim 8, further comprising an inner barrier having a substantially same depth as the raised ridge, wherein the inner barrier is disposed between the conduit receiving hole and the ventilation holes.

10. A method of containing a plurality of elements of a stoma treatment adjacent to a stomatic site, the method comprising:
engaging a stomatic site containment device of claim 8 to a skin of a patient so that a raised ridge of said stomatic site containment device circumscribes both the stomatic site and the plurality of elements of the stoma treatment.
